(19) United States
(12) Patent Application Publication
(10) Pub. No.: US 2009/0117794 A1
(43) Pub. Date: May 7, 2009

(54) Composition for forming antifogging coating and fabric textile applying the same method of forming the antifogging coating

(75) Inventors: Hung-Chiao Cheng, Hsinchu City (TW); Wen-Hann Chou, Taipei County (TW); Ya-Hui Lin, Hsinchu City (TW); Yu-Ming Wang, Taichung City (TW); Yeu-Kuen Wei, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INDUSTRIAL TECHNOLOGY RESEARCH INSTITUTE, Hsinchu (TW)

(21) Appl. No.: 12/011,839

(22) Filed: Jan. 30, 2008

(30) Foreign Application Priority Data
Nov. 7, 2007 (TW) 96142082

(51) Int. Cl. C09K 3/18; B32B 5/18

(52) U.S. Cl. 442/77; 523/169; 523/122; 523/102; 442/76

(57) ABSTRACT

A composition for forming an antifogging coating is provided. The composition includes substantially 0.1 to 10 parts by weight of numerous ultrafine particles, substantially 0.1 to 10 parts by weight of a polymeric electrolyte and substantially 80 to 100 parts by weight of water. When a layer of the composition on a material surface is dried, the antifogging coating of super-hydrophilic nanostructure constructed by these ultrafine particles is formed on the material surface.

This application claims the benefit of Taiwan application Serial No. 96142082, filed Nov. 7, 2007, the subject matter of which is incorporated herein by reference.

### BACKGROUND OF THE INVENTION

1. Field of the Invention

The invention relates in general to a composition for forming an antifogging coating and a fabric textile applying the same and a method of forming the antifogging coating, and more particularly to a composition for forming an antifogging coating of super-hydrophilic nanostructure and a fabric textile applying the same and a method of forming the antifogging coating.

2. Description of the Related Art

When material with smooth surface such as glass or lens contacts with vapor, little fog droplets are condensed easily on the smooth surface of the material and a thin layer of fog is formed thereon. When the material is transparent, the thin layer of fog will reduce the transmittance of the material or deteriorate the visibility, not only increasing the inconvenience of regular applications, but also affecting safety in driving or work. For example, the fog forms on the lens of a helmet or on the windshield of a vehicle may affect the visibility of the driver; the fog grows on the safety glasses of a construction worker may greatly increase the risk; the fog covers on the windows of a refrigerator or on the mirror in the bathroom lowering the clarity; or even the liquid droplets condensed from the fog on the glass of a green house may moisturize the plants or crop to deteriorate the quality thereof. Thus, there has always been a strong demand for antifogging products.

The most commonly used method for preventing the formation of the layer of fog is to perform surface modification on the surface of the product, on which an antifogging coating is plated during the manufacturing process. However, such method incurs more manufacturing processes and manufacturing cost, and is unable to meet the requirement of cost reduction, particularly for those products of low material cost and of relative small surface area. Currently, there are various antifogging sprays or antifogging coating materials available in the market. These antifogging products contain an ingredient of hydrophilic base which is to be applied onto the surface where the formation of fog is undesired. However, such ingredient of hydrophilic base may be washed away easily and can not stay on the surface for long. These antifogging sprays or antifogging coating materials have drawbacks like short durability and limited antifogging effect. Thus, user has to apply the antifogging spray or antifogging coating frequently, largely reducing the convenience.

### SUMMARY OF THE INVENTION

The invention is directed to a composition for forming an antifogging coating and a fabric textile applying the same and a method of forming the antifogging coating. After the liquid film of the composition is dried, numerous ultrafine particles in the composition are stacked to form the antifogging coating. The invention at least has the advantages including simple applying, a wide range of suitable applications and long lasting antifogging effect.

According to a first aspect of the present invention, a composition for forming an antifogging coating is provided. The composition includes substantially 0.1 to 10 parts by weight of numerous ultrafine particles, substantially 0.1 to 10 parts by weight of a polymeric electrolyte and substantially 80 to 100 parts by weight of water. When a layer of the composition on a material surface is dried, the antifogging coating of super-hydrophilic nanostructure constructed by these ultrafine particles is formed on the material surface.

According to a second aspect of the present invention, a fabric textile including a substrate and a composition is provided. The substrate has numerous capillary-size pores. The composition moisturizes the substrate via the capillary-size pores. The composition used for forming an antifogging coating includes substantially 0.1 to 10 parts by weight of numerous ultrafine particles, substantially 0.1 to 10 parts by weight of a polymeric electrolyte and substantially 80 to 100 parts by weight of water. When a layer of composition on a material surface is dried, the antifogging coating of super-hydrophilic nanostructure constructed by these ultrafine particles is formed on the material surface.

According to a third aspect of the present invention, a method of forming an antifogging coating is provided. First, a layer of composition is formed on a material surface. The composition includes substantially 0.1 to 10 parts by weight of numerous ultrafine particles, substantially 0.1 to 10 parts by weight of a polymeric electrolyte and substantially 80 to 100 parts by weight of water. When a layer of composition is dried, the ultrafine particles are stacked on material surface to form the antifogging coating of super-hydrophilic nanostructure.

The invention will become apparent from the following detailed description of the preferred but non-limiting embodiments. The following description is made with reference to the accompanying drawings.

### BRIEF DESCRIPTION OF THE DRAWINGS

FIG. 1 is a perspective of ultrafine particles stacked on a material surface.

### DETAILED DESCRIPTION OF THE INVENTION

A composition for forming an antifogging coating is provided in a preferred embodiment of the invention. The composition includes numerous ultrafine particles, a polymeric electrolyte and water. When a layer of composition applied on a material surface is dried, an antifogging coating of super-hydrophilic nanostructure constructed by these ultrafine particles is formed on the material surface. The embodiment is disclosed below for elaborating the invention. However, embodiment is for the purpose of elaboration only, not for limiting the scope of protection of the invention.

### Composition

The composition for forming an antifogging coating according to the present embodiment of the invention includes substantially 0.1 to 10 parts by weight of numerous ultrafine particles; substantially 0.1 to 10 parts by weight of polymeric electrolyte, and substantially 80 to 100 parts by weight of water. In the composition, the ultrafine particles are in the form of nano-powder which is insoluble in water. The examples of ultrafine particles include nano-powder of silicon dioxide, nano-powder of aluminum oxide and nano-powder of zinc oxide. The ultrafine particles are dispersed in the water so that the composition is in suspension state. Because the average diameter of ultrafine particles affects the turbidity of suspension, the transparency of the composition decreases when the average diameter of ultrafine particles increases. Particularly, when the composition is applied onto a transparent material surface, the transmittance of the material may be affected by the size of the particles. Thus, the average particle diameter of the ultrafine particles is preferred to be smaller than or equal to 50 nm, such that the antifogging coating is formed with excellent light transmittance.

Polymeric electrolyte is used for maintaining the dispersion of the ultrafine particles in water. When the layer of the composition on the material surface is dried, the polymeric electrolyte keeps the ultrafine particles from coagulating and avoids the formation of spots, stripes or patterns of the like on the dried antifogging coating. Thus, the uniformity and appearance of the antifogging coating will be maintained. Examples of the polymeric electrolyte applied here include carboxymethyl cellulose (CMC), polyallylamine hydrochloride, polyamine and polyacrylic amide.

In the composition of the present embodiment of the invention, the amount of water is large enough for the ultrafine particles to disperse in the composition uniformly, and the sufficient amount of water also facilitate applying of the composition. The composition preferably contains water having low impurities, such as deionized water, to avoid the precipitation or agglomeration resulting from active and unstable ions in the water, such as calcium ions, magnesium ions or iron ions. Therefore, the antifogging coating can be formed with excellent uniformity.

In addition to the ultrafine particles, the polymeric electrolyte and water, the composition of the present embodiment of the invention further includes substantially 1 to 20 parts by weight of a volatile organic solvent. It is preferable to select the volatile organic solvent that does not separate from water, such as ethanol, isopropanol or acetone. The solvent used here is for increasing the drying efficiency of the composition on a material surface. Moreover, the composition can further include a functional additive which is preferably miscible in the water but does not interact with other ingredients in the composition. Examples of the functional additive include perfume, antibacterial and sanitary agent. Thus, when the composition is applied on the material surface, the composition also implements sterilizing and cleaning functions, so that the antifogging coating formed accordingly carries aroma or sterilization effect.

When the layer of the composition on a material surface is dried, the ultrafine particles are stacked on the material surface to form a porous antifogging coating of super-hydrophilic nanostructure. The apertures in the super-hydrophilic nanostructure reduce the contact angle of the fog droplets to the antifogging coating, so that the antifogging effect is achieved.

### Fabric Textile

The composition according to the preferred embodiment of the invention is applicable to a fabric textile. The fabric textile includes a substrate having numerous capillary-size pores, and the composition moisturize the substrate via the capillary-size pores. The substrate is a soft absorbent material, and is exemplified here by non-woven fabric, woven fabric or paper towel. Let the paper towel be taken for example. The paper towel includes numerous alternating fibers, and the gaps between these fibers form capillary-size pores. The composition of the present embodiment of the invention which is in suspension state is absorbed to the paper towel via the capillary-size pores. The user can use a wet paper towel moisturized by the composition to apply the composition to the material surface where an antifogging coating is to be formed. The fabric textile moisturized by the composition has the virtue of simple applying and easy carrying.

### Method of Forming Antifogging Coating

The method of forming an antifogging coating according to the present embodiment of the invention mainly includes the step of forming a layer of composition on a material surface. For example, by wiping the material surface with the above-mentioned wet paper towel moisturized with the composition, the composition can be applied onto the material surface. However, the composition can also be accommodated in a spray bottle and then sprayed on the material surface by means of high pressure gas in the bottle or a pressing nozzle. Any one who is skilled in the technology of the invention will understand that commonly used methods, such as painting, immersing, rolling or other manners that uniformly coat a liquid onto a material surface, are also applicable to the technology of the invention. In addition, the composition of the preferred embodiment of the invention can be applied to a wide range of materials to provide antifogging effect. In practical application, the composition can be applied on a substantially smooth and unmodified surface, so that ultrafine particles can be attached onto the surface, for example onto the surface of glasses, glass windows, mirror, desktop, acrylic board, PC plastic board, PET plastic board, food packing bag or ceramics.

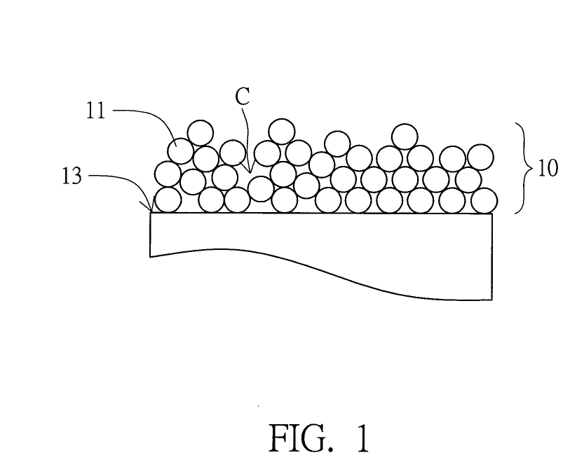

After the layer of the composition is formed on the material surface, preferably, the material surface is left still until the composition layer is dried. However, according to the environment or condition of applying the composition, the manner of drying the composition layer can also be baking, wind-drying or other well-known drying methods. After the layer of the composition is dried, that is, water and the volatile organic solvent are evaporated, the ultrafine particles are gradually stacking onto the material surface. Referring to FIG. 1, a perspective of ultrafine particles stacked on the material surface is shown. When water is evaporated, the ultrafine particles 11 are gradually stacking onto the material surface 13 to form an antifogging coating 10 having numerous apertures C from the state of being suspended and dispersed in water. Thus, the antifogging coating 10 is hydrophilic and is capable of increasing the contact area of fog droplets with respect to the material surface 13. Further, the contact angle of the fog droplets to the material surface 13 is decreased.

Compared with conventional antifogging coating containing chemical ingredients of hydrophilic base, the antifogging coating 10 of the present embodiment of the invention is constructed by nano-level ultrafine particles 11 stacked on the material surface. The nano-level ultrafine particles 11 have better adhesion to the material surface 13, and the antifogging coating 10 with porous structure is less likely to be washed away and has extended antifogging effect. Moreover, the material surface 13 can be preferably precleaned before forming the layer of the composition, so as to remove the impurities like grease and dust on the material surface 13. By doing so, the stacking uniformity of the ultrafine particles 11 on the material surface 13 is enhanced, and the quality of the antifogging coating 10 as well as the antifogging effect are both improved.

### Test Result

Referring to attached drawings 1 and 2, which individually show the contact angle of the fog droplets to the material surface before and after the formation of the antifogging coating. The material surface here is exemplified by a glass mirror surface, and an antifogging coating is formed by applying the composition of the present embodiment onto the material surface. As indicated in attached drawing 1, before the antifogging coating is formed, the contact angle of the fog droplets to the material surface is approximately 69.58°. After an antifogging coating is formed on the material surface, the contact angle of the fog droplets to the material surface is approximately 4.7°, as indicated in attached drawing 2. Thus, according to the test result, when the layer of the composition on a material surface is dried to form a porous antifogging coating of super-hydrophilic nanostructure, the contact angle of fog droplets is effectively reduced to achieve the antifogging effect.

On the other hand, the composition of the present embodiment of the invention is prepared as composition A and composition B according to different ingredient proportions. Then, composition A and composition B are tested for antifogging durability. Referring to Table 1, ingredients and proportions thereof in composition A and composition B are shown. Composition A includes 10 parts by weight of nano-level powder, 10 parts by weight of polymeric electrolyte, 10 parts by weight of isopropanol (IPA) and 90 parts by weight of deionized water. Composition B includes 10 parts by weight of nano-level powder, 10 parts by weight of polymeric electrolyte and 100 parts by weight of deionized water.

TABLE 1

| | Composition | Composition |
|---|---|---|
| | A | B |
| Nano-level Powder (parts by | 10 | 10 |
| weight) | | |
| Electrolyte (parts by weight) | 10 | 10 |
| Volatile Organic Solvent (parts | 10 | 0 |
| by weight) | | |
| Water (parts by weight) | 90 | 100 |

Antifogging durability test includes the following steps. The test begins with step 1 first. Composition A and composition B are respectively applied on a 2.5 cm*7.5 cm glass piece, and then are dried in the shade. Next, the test proceeds to step 2. The two glass pieces with dried composition are placed at 10 cm from the vapor nozzle of an electro-heated water-vapor machine, so that the vapor can be sprayed on the two glass pieces for 10 minutes and the formation of fog on the glass pieces is observed by naked eyes. During the durability test, vapor is sprayed onto the glass pieces once a day (step 2). Besides, on the 8^{th} day, the two glass pieces having been tested for 7 days are immersed in hot water of 100° C. for 10 minutes, and then step 2 of spraying vapor is performed. Referring to Table 2, the results of antifogging durability test are shown.

TABLE 2

| | | Test Result Of | Test Result Of |
|---|---|---|---|
| Days | Types of Test | Composition A | Composition B |
| 1 | Water-Vapor Test | OK | OK |
| 2 | Water-Vapor Test | OK | OK |
| 3 | Water-Vapor Test | OK | OK |
| 4 | Water-Vapor Test | OK | OK |
| 5 | Water-Vapor Test | OK | OK |
| 6 | Water-Vapor Test | OK | OK |
| 7 | Water-Vapor Test | OK | OK |
| 8 | Hot Water Immersion | OK | OK |
| | And Water-Vapor Test | | |
| 9 | Water-Vapor Test | Fail | Fail |

The test results show that whether the composition contains the volatile organic solvent for accelerating the dried or not, the porous antifogging coating of super-hydrophilic nanostructure of the invention which is formed by way of stacking nano-level powder approximately maintains the antifogging effect for around 8 days. By enhancing the durability of the antifogging coating, the number of times for user to repeatedly apply the composition is largely reduced, hence increasing the convenience of using the composition and relatively saving the consumption of the composition.

According to the composition for forming the antifogging coating and the fabric textile applying the same and method of forming the antifogging coating disclosed in the above-mentioned embodiment of the invention, the composition including ultrafine particles of nano-level powder is applied on the material surface where the antifogging coating is desired. When the composition is dried, ultrafine particles are stacked on the material surface to form the porous antifogging coating of super-hydrophilic nanostructure, so that the fog droplet is flattened, and the contact angle of the fog droplet is decreased. The composition applied in the fabric textile has better portability and convenience, such as utulized by way of wet paper towel. Moreover, the antifogging coating formed by the stacking of ultrafine particles of nano-level powder is not easy to be washed away from the material surface, hence having excellent durability. Besides, the composition can be widely used in any material surface where antifogging is required, therefore having good application flexibility.

While the invention has been described by way of example and in terms of preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A composition for forming an antifogging coating, the composition comprising:
substantially 0.1 to 10 parts by weight of a plurality of ultrafine particles;
substantially 0.1 to 10 parts by weight of a polymeric electrolyte; and
substantially 80 to 100 parts by weight of water;
wherein when a layer of the composition on a material surface is dried, the antifogging coating of super-hydrophilic nanostructure constructed by these ultrafine particles is formed on the material surface.

2. The composition according to claim 1, wherein the ultrafine particles are in powder form whose average particle diameter is smaller than or equal to 50 naometer (nm).

3. The composition according to claim 1, wherein the ultrafine particles comprises silicon dioxide powder, aluminum oxide powder or zinc oxide powder.

4. The composition according to claim 1, wherein the polymeric electrolyte comprises carboxymethyl cellulose (CMC), polyallylamine hydrochloride, polyamine or polyacrylic amide.

5. The composition according to claim 1, wherein the ultrafine particles are insoluble in water and are dispersed in the water so that the composition is in suspension state.

6. The composition according to claim 5, wherein when the layer of the composition on the material surface is dried, the polymeric electrolyte is used for maintaining the dispersion of the ultrafine particles.

7. The composition according to claim 1, wherein the composition further comprises:
substantially 1 to 20 parts by weight of a volatile organic solvent.

8. The composition according to claim 7, wherein the volatile organic solvent comprises ethanol, isopropanol or acetone.

9. The composition according to claim 1, wherein the antifogging coating is formed by stacking of the ultrafine particles and has a plurality of apertures.

10. The composition according to claim 1, wherein the composition further comprises:
substantially 0.1 to 10 parts by weight of a functional additive.

11. The composition according to claim 10, wherein the functional additive comprises perfume, antibacterial or sanitary agent.

12. A fabric textile, comprising:
a substrate having a plurality of capillary-size pores; and
a composition for forming an antifogging coating, wherein the composition moisturizing the substrate via the capillary-size pores comprises:
substantially 0.1 to 10 parts by weight of a plurality of ultrafine particles;
substantially 0.1 to 10 parts by weight of a polymeric electrolyte; and
substantially 80 to 100 parts by weight of water;
wherein when a layer of the composition on a material surface is dried, the antifogging coating of super-hydrophilic nanostructure constructed by these ultrafine particles is formed on the material surface.

13. The fabric textile according to claim 12, wherein the ultrafine particles are in powder form whose average particle diameter is smaller than or equal to 50 nanometer (nm).

14. The fabric textile according to claim 12, wherein the ultrafine particles comprises silicon dioxide powder, aluminum oxide powder or zinc oxide powder.

15. The fabric textile according to claim 12, wherein the polymeric electrolyte comprises carboxymethyl cellulose, polyallylamine hydrochloride, polyamine or polyacrylic amide.

16. The fabric textile according to claim 12, wherein the composition further comprises:
substantially 1 to 20 parts by weight of a volatile organic solvent.

17. The fabric textile according to claim 16, wherein the volatile organic solvent comprises ethanol, isopropanol or acetone.

18. The fabric textile according to claim 12, wherein the antifogging coating is formed by stacking of the ultrafine particles has a plurality of apertures.

19. The fabric textile according to claim 12, wherein the composition further comprises:
substantially 0.1 to 10 parts by weight of a functional additive.

20. The fabric textile according to claim 19, wherein the functional additive comprises perfume, antibacterial or sanitary agent.

21. The fabric textile according to claim 12, wherein the substrate is a soft absorbent material.

22. The fabric textile according to claim 21, wherein the substrate is a non-woven fabric, a woven fabric or a paper towel.

23. A method of forming an antifogging coating, comprising:
forming a layer of a composition on a material surface, wherein the composition comprises substantially 0.1 to 10 parts by weight of a plurality of ultrafine particles, substantially 0.1 to 10 parts by weight of a polymeric electrolyte and substantially 80 to 100 parts by weight of water;
wherein when the layer of composition is dried, the ultrafine particles are stacked on the material surface to form the antifogging coating of super-hydrophilic nanostructure.

24. The method according to claim 23, wherein the ultrafine particles are dispersed in the composition, and when the layer of composition is dried, the polymeric electrolyte is used for maintaining the dispersion of the ultrafine particles.

25. The method according to claim 23, wherein the antifogging coating is formed with a plurality of apertures.
